(19) United States
(12) Patent Application Publication
(10) Pub. No.: US 2024/0315482 A1
(43) Pub. Date: Sep. 26, 2024

(54) Beverage Preparation Device

(71) Applicant: K-FEE SYSTEM GMBH, Bergisch Gladbach (DE)

(72) Inventors: Marc Krüger, Bergisch Gladbach (DE); Günter Empl, Bergisch Gladbach (DE)

(21) Appl. No.: 18/579,948

(22) PCT Filed: Jul. 20, 2022
(86) PCT No.: PCT/EP2022/070411

§ 371 Date: Jan. 17, 2024

(30) Foreign Application Priority Data
Jul. 20, 2021 (DE) 10 2021 207 768.4

(51) Int. Cl. A47J 31/44; A47J 31/36; A47J 31/52; B65D 85/804

(52) U.S. Cl. CPC A47J 31/4492; A47J 31/3633; A47J 31/525; B65D 85/8058

(57) ABSTRACT

A beverage preparation device for preparing a beverage with a single serve capsule that includes: a base element and a periphery projecting laterally from the base element, a lid film fastened to the periphery, a beverage raw material disposed in the cavity, and an identification mark on a side of the periphery that faces away from the lid film; the beverage preparation device including a brewing chamber configured to receive the capsule; the brewing chamber including a first brewing chamber element and a second brewing chamber element which are movable relative to one another; the beverage preparation device including at least one detection means configured to detect the identification mark; the brewing chamber and the single serve capsule are configured to be non-rotating during preparation of the beverage and in the open position and/or the closed position, is configured so that the capsule is pivotable and/or rotatable.

### CROSS REFERENCE TO RELATED APPLICATIONS

This application is a US National Stage of PCT/EP2022/070411 filed Jul. 20, 2022, which claims priority to DE 10 2021 207 768.4 filed Jul. 20, 2021, all of which are hereby incorporated by reference herein for all purposes.

### FIELD

The present invention relates to a beverage preparation device for preparing a beverage by means of a single serve capsule, the single serve capsule having a base element with an open side and a periphery projecting laterally from the base element on the open side; a lid film which closes, in particular hermetically, the open side being fastened to the periphery; a beverage raw material being disposed in the cavity formed by the lid film and the base element; the single serve capsule on the side of the periphery facing away from the lid film having an identification mark; the beverage preparation device having a brewing chamber which is provided to receive the single serve capsule; the brewing chamber comprising a first brewing chamber element and a second brewing chamber element which are movable relative to one another between an open position, in which the single serve capsule is insertable into the brewing chamber and/or removable from the brewing chamber, and a closed position, in which a liquid is able to be directed into the single serve capsule for preparing a beverage; the beverage preparation device having at least one detection means for detecting the identification mark. Furthermore, the present invention relates to a system composed of a beverage preparation device and a single serve capsule, to a method for preparing a beverage by means of such a system, and to the use of a single serve capsule for preparing a beverage in a beverage preparation device of this type, or in a system of this type.

### BACKGROUND

Beverage preparation devices and single serve capsules of this type are well known. For instance, a single serve capsule of this type is disclosed in European patent EP 3 023 362 B1 of the applicant. The company Nestle utilizes single serve capsules of this type in their Vertuo single serve capsule system, for example. The preparation of the beverage herein takes place by centrifugation of the single serve capsule in the brewing chamber of the single serve capsule machine. The single serve capsule is of a rotationally symmetrical construction and is rotated about its central axis. Water is injected through the lid film at a central position and the finished beverage, for example coffee, leaves the single serve capsule through the lid film in the region of the flange-type periphery. During rotation, the identification mark is read by a detection means installed in the brewing chamber, and the detected items of information are used to control the preparation of the beverage, for example the supplied volume of water and/or the rotating speed of the centrifugation. Since the single serve capsule is rotated, the identification mark along the entire circumference of the periphery can be easily read by a stationary detection means.

Such a beverage preparation device having a rotating brewing chamber is complex in terms of construction, intensive in terms of maintenance, and cost-intensive in production. A multiplicity of other single serve capsule machines, which are of a simpler construction and do not require centrifugation, are known. However, these single serve capsule machines cannot read the identification mark located on the lower side of the periphery, i.e. the side facing away from the lid film. However, it is desirable to detect the identification mark in order to identify the capsule so as to protect the single serve capsule machine from damage by unsuitable single serve capsules and/or to transmit optimized beverage preparation parameters to the single serve capsule machine and, as a result, enable a preparation mode optimally suited to the respective beverage raw material contained in the single serve capsule.

### SUMMARY

It is therefore an object of the present invention to make available a beverage preparation device which can also detect an identification mark on the lower side of the periphery of a single serve capsule without centrifugation of the brewing chamber.

The object is achieved by a beverage preparation device for preparing a beverage by means of a single serve capsule, the single serve capsule having a base element with an open side and a periphery projecting laterally from the base element on the open side; a lid film which closes, in particular hermetically, the open side being fastened to the periphery; a beverage raw material being disposed in the cavity formed by the lid film and the base element; the single serve capsule on the side of the periphery facing away from the lid film having an identification mark; the beverage preparation device having a brewing chamber which is provided to receive the single serve capsule; the brewing chamber comprising a first brewing chamber element and a second brewing chamber element which are movable relative to one another between an open position, in which the single serve capsule is insertable into the brewing chamber and/or removable from the brewing chamber, and a closed position, in which a liquid is able to be directed into the single serve capsule for preparing a beverage; the beverage preparation device having at least one detection means for detecting the identification mark, wherein the brewing chamber and the single serve capsule are provided so as to be immovable, in particular non-rotating, during the preparation of the beverage.

According to the invention, the detection means is thus disposed in such a manner that an identification mark on the side of the periphery facing away from the lid film, hereunder also referred to as the lower side of the periphery, can be read without it being necessary that the single serve capsule is rotated relative to the detection means. It is particularly advantageously made possible as a result to use a single serve capsule with an identification mark on the lower side of the periphery also in a beverage preparation device which does not rotate the single serve capsule during the preparation of the beverage. It is advantageously possible by way of such a single serve capsule to prevent that single serve capsules which are not envisaged for the beverage preparation device, or are incompatible with the latter, are introduced into said beverage preparation device or at least prepared in the latter. Furthermore, by way of the identification mark it is possible for the beverage preparation device to recognize which type of single serve capsule is located in the brewing chamber, and to correspondingly control the beverage preparation process, or the beverage production process, i.e. for example to correspondingly adjust the quantity of liquid, the pressure of the latter and/or the temperature of the latter. The liquid is preferably water. The beverage preparation device is preferably a beverage preparation machine, in particular a coffee machine, here thus a single serve capsule coffee machine.

Advantageous design embodiments and refinements of the invention can be derived from the teachings herein and from the description with reference to the drawings. These advantageous design embodiments and refinements also relate to the further subject matter of the invention, and vice versa.

According to a preferred embodiment of the present invention it is provided that the beverage preparation device has an introduction opening for introducing the single serve capsule, the detection means being disposed along the path between the introduction opening and the brewing chamber, preferably in an introduction duct which directs, in particular in a form-fitting manner, the single serve capsule from the introduction opening to the brewing chamber. A means by way of which the single serve capsule can selectively be held in an intermediate position is particularly preferably provided in the introduction duct, in particular below the detection means. As a result, it is particularly advantageously possible to prevent that an unsuitable single serve capsule makes its way into the brewing chamber. If the identification mark is not detected, or said identification mark contains the item of information that the single serve capsule is incompatible with the beverage preparation device, the means does not permit the single serve capsule to drop into the brewing chamber under the influence of gravity in the open position. Alternatively or additionally, the brewing chamber is initially in the closed position, in which the single serve capsule cannot make its way into the brewing chamber, and is moved to the open position only if an identification mark is detected or the identification mark contains an item of information which makes it possible to establish that this is a compatible single serve capsule. In this case, the user has to remove the single serve capsule from the introduction duct again.

According to a preferred embodiment of the present invention it is provided that the first brewing chamber element and/or the second brewing chamber element comprise/comprises the detection means, the detection means preferably being configured in such a manner that the identification mark is detectable in the closed position. This embodiment is advantageous because it accelerates the preparation of the beverage. Instead of initially holding the single serve capsule in an intermediate position, the single serve capsule is incorporated directly into the brewing chamber and the latter transferred to the closed position. If the identification mark is identified, the preparation of the beverage can start immediately, preferably as a function of preparation parameters encoded by the identification mark. If the identification mark is not identified, or the identification mark contains an item of information which makes it possible to establish that this is an incompatible single serve capsule, the brewing chamber can be transferred back to the open or opened position again, and the single serve capsule can be ejected, in particular by way of an ejection opening.

According to a preferred embodiment of the present invention it is provided that the detection means is provided on an external side of the beverage preparation device, preferably in a depression which at least partially receives the single serve capsule. The depression is particularly preferably provided on the upper side of the beverage preparation device. For example, a depression receiving the single serve capsule is provided on the upper side of the housing of the beverage preparation device, the detection means being in particular an at least partially, preferably completely, encircling optical sensor which detects the identification mark. If the identification mark is detected, or it is established that the identification mark contains an item of information which makes it possible to establish that this is a compatible single serve capsule, an introduction opening is released, for example, and/or the user is advised, for example by way of an optical and/or acoustic signal, that the single serve capsule can be inserted into the beverage preparation device. The user can then grip the single serve capsule on the encircling periphery, for example, retrieve said single serve capsule from the depression and introduce it into the beverage preparation device by way of an introduction opening. This embodiment is likewise particularly advantageous because the user in this way can for example easily test a plurality of single serve capsules and can pick a suitable single serve capsule without having to laboriously remove the single serve capsules from an introduction duct, or without said single serve capsules being transferred unused in particular into a single serve capsule collection container for used single serve capsules. An optical and/or acoustic signaling means is most particularly preferably provided in the region of the depression. Even more preferably, an illumination means which at least partially surrounds the depression is provided so that the illumination means lights up green, in particular in the shape of a green doughnut, in the event of a positive detection, and lights up red, in particular in the shape of a red doughnut, in the event of failed detection and/or a negative detection. This represents a solution which is easy to understand and comfortable for the user.

According to a preferred embodiment of the present invention it is provided that the beverage preparation device comprises a control unit which is connected to the detection means in such a manner that the detection means in the event of a detected identification mark sends an item of information to the control unit, the control unit preferably being provided in such a manner that the latter controls the beverage preparation device at least in part as a function of the item of information received. The control unit is particularly preferably connected to a liquid conveying system of the beverage preparation device, in particular to a pump, to a drive means which causes the relative movement of the first brewing chamber element and of the second brewing chamber element, and/or to the means provided in the introduction duct for holding the single serve capsule in an intermediate position. The control installation most particularly preferably releases the activation of at least one of the aforementioned components, and/or controls the latter. For example, the control unit controls the liquid volume conveyed by the pump, the temperature of said liquid and/or a temporal profile of the conveyed volume of liquid and/or the temperature of the latter. Alternatively or additionally, the control unit controls the relative movement of the first brewing chamber element and of the second brewing chamber element between the open and the closed position, and or vice versa, said relative movement being caused by a drive means. It is conceivable that the first brewing chamber element and/or the second brewing chamber element are/is moved herein. The control unit is preferably configured in such a manner that the beverage preparation device can be put in operation, and in particular the pump is able to be activated, only if the determined identification mark agrees with a reference identification mark.

According to a preferred embodiment of the present invention it is provided that the detection means comprises an optical sensor, in particular a CCD sensor and/or a camera, the optical sensor preferably operating in a wavelength range of 100 to 400 nm, 400 to 600 nm, and/or 800 nm to 1 mm. An optical sensor of this type is a particularly simple and proven method for detecting an identification mark. Moreover, sensors of this type are of a particularly advantageously small construction, and therefore advantageously enable the integration in the brewing chamber.

According to a preferred embodiment of the present invention it is provided that the detection means has an optical sensor for emitting electromagnetic radiation, preferably in a wavelength range of 100 to 400 nm, 400 to 600 nm, and/or 800 nm to 1 mm, the optical transmitter being in particular an LED and/or a laser diode. The person skilled in the art understands that the light conditions in an (at least partially) closed brewing chamber are insufficient in order to detect the identification mark. Therefore, the optical transmitter provides electromagnetic radiation, in particular (UV/IR) light which is reflected by the identification mark and can then be detected by an optical sensor. The detection means particularly preferably comprises an optical sensor and an optical transmitter.

According to a preferred embodiment of the present invention it is provided that the detection means has a detection face in which an identification mark is detectable, the detection face in terms of the periphery of the single serve capsule comprising an angular range from 1° to 360°, preferably to 180°, particularly preferably to 90°, most particularly preferably to 45°, and even more preferably to 30°. For example, the detection means comprises optical beam-forming means and/or a multiplicity of optical sensors in such a way that the identification mark is detectable in a large angular range. Most particularly preferably, the brewing chamber comprises an at least partially annular detection means, or an at least partially annular detection face, respectively. As a result, it is particularly advantageously possible to detect the identification mark in a large angular range and, in particular in the case of a single encircling identification mark, to completely detect the identification mark without requiring any movement of the single serve capsule and/or of the detection means for this purpose. A beverage preparation device of a simple construction is able to be provided in a simple manner as a result.

According to a preferred embodiment of the present invention it is provided that the detection means for detecting the identification mark of the single serve capsule is provided to be pivotable and/or rotatable, preferably in an angular range from 1° to 360°, particularly preferably to 180°, most particularly preferably to 90°, even more preferably to 45°, and in particular to 30°. It is conceivable here that the detection means is pivoted in a guide so as to cover a larger angular range, and/or that the brewing chamber element comprising the detection means is at least in portions rotated relative to the other brewing chamber element and/or relative to the single serve capsule about an axis, for example the centric central axis of the single serve capsule, in order to detect the identification mark. As a result, it is advantageously possible that a detection means with a comparatively small detection face is used but a large region of the identification mark is nevertheless able to be detected. For example, the detection means, proceeding from an initial position, is rotated in both directions through an angular range of 90° or 180°. As a result, at least half of the circumference, or advantageously the entire circumference, of the periphery and thus the entire identification mark is detectable.

According to a preferred embodiment of the present invention it is provided that the beverage preparation device in the open and/or the closed position is provided in such a manner that the single serve capsule for detecting the identification mark by the detection means is provided to be pivotable and/or rotatable, preferably in an angular range from 1° to 360°, particularly preferably to 180°, most particularly preferably to 90°, even more preferably to 45°, and in particular to 30°. The detection means herein is particularly preferably disposed so as to be stationary relative to the beverage preparation device. This embodiment is most particularly advantageous because no complex pivoting or rotating of the detection means and/or of at least one brewing chamber part is required in this way, but rotation is instead performed by the single serve capsule, the latter being easier to implement in terms of construction.

According to a further preferred embodiment of the present invention it is provided that the single serve capsule as well as the detection means and/or the brewing chamber element comprising the detection means are/is pivoted and/or rotated, in particular in opposite directions, through a predetermined angular range. As a result, it is advantageously possible that the identification is detected along the entire peripheral circumference, but neither of the two parts has to perform any movement by 360°, for example.

A further subject matter of the present invention is a system composed of a beverage preparation device according to the invention and a single serve capsule, the single serve capsule having a base element with an open side and a periphery projecting laterally from the base element on the open side; a lid film which closes, in particular hermetically, the open side being fastened to the periphery; a beverage raw material being disposed in the cavity formed by the lid film and the base element; the single serve capsule on the side of the periphery facing away from the lid film having an identification mark.

The advantages and refinements explained in the context of the system according to the invention also apply in an analogous manner to the other subject matter of the present invention, and vice versa.

The single serve capsule according to the invention is produced from, for example, plastics material, a natural material, a biologically decomposable material, a metal such as aluminum, for instance, a metal alloy and/or a metal laminate, for example an aluminum foil which is coated with a plastics material on one side or both sides, and typically has a base element, in particular a deep-drawn base element, which is preferably shaped so as to be frustoconical, cylindrical, dome-like or hemispherical, respectively. The base element preferably has a lateral wall and a base region. A hole can particularly preferably be provided in the base region, but said hole is closed by a film/foil fastened to the inside or the outside on the base region. The film/foil may be able to be pierced by the beverage preparation device, or be able to be torn off by a user. In the latter case, the foil/film most particularly preferably has a tab. At the end of the single serve capsule lying opposite the base region, said single serve capsule has a periphery which projects laterally, in particular horizontally, from the base element. This periphery is preferably configured in the manner of a flange. A lid film, which is impermeable and/or perforated at least in regions and/or porous at least in regions, is fastened to the periphery, in particular sealed and/or adhesively bonded thereto, and in this way closes a cavity in the base element. The lid film is preferably configured in one layer or multiple layers and can at least in part be made of a metal, in particular aluminum, and/or a plastics material. The lid film can be made of the same material as the base element, or of a material dissimilar to the latter. The lid film thus closes an open end of the single serve capsule.

The beverage raw material, which is able to be extracted and/or dissolved by a liquid, in particular water, for example, is filled into the cavity of the single serve capsule. The beverage raw material comprises in particular coffee powder, preferably ground roasted coffee, chocolate powder, milk powder, tea, or the like. Alternatively, it is conceivable that the beverage raw material comprises a beverage extract such as, for example, instant coffee. The single serve capsule preferably has one or a plurality of installed elements in the cavity, such as, for example, a filter element, a liquid distribution element, a nonwoven fabric, a felt, a barrier film and/or the like. Should a felt and a nonwoven fabric be provided, said felt and nonwoven fabric are preferably connected to one another. The felt and/or the nonwoven fabric can be provided in multiple layers, whereby the layers may differ in terms of the primary material used and/or the processing of the latter.

It is now provided according to the invention that this single serve capsule has an identification mark which makes it possible in particular to individualize the respective single serve capsule. In the context of the invention, individualizing preferably means that the respective single serve capsule can be assigned to a group suitable for the associated beverage preparation machine.

It is not necessary for the beverage preparation device to identify which single serve capsule this is specifically, but only for said beverage preparation device to identify that the respective single serve capsule belongs to a group of single serve capsules that are suitable for the beverage preparation device. Individualizing means in particular that single serve capsules that are unsuitable for the respective beverage preparation device are not able to be introduced into the brewing chamber and/or drop directly out of the brewing chamber again, and/or that the beverage preparation device can only be set in operation with the correct, i.e. compatible, single serve capsules. The detection means detects this identification mark and preferably compares the latter with a stored identification mark, i.e. a reference identification mark. The beverage preparation device can preferably be set in operation only, in particular a pump supplying the liquid is activatable or activated only, if the ascertained identification mark agrees with the reference identification mark. Alternatively or additionally, the identification mark prevents that the single serve capsule is introduced into the beverage preparation device, in particular into the brewing chamber. Provided alternatively or additionally in an introduction duct are in particular means, in particular mechanical means, particularly preferably a flap which at least partially closes the introduction duct, that prevent an incorrect single serve capsule from making its way into the beverage preparation device, in particular the introduction duct.

Particularly preferably provided within the cavity is a filter element which divides the cavity into a first region for receiving the beverage raw material and into a second region for temporarily storing a beverage extract, whereby it is particularly preferably provided that the filter element comprises a nonwoven material and/or a felt material.

Preferably provided within the cavity is a liquid distribution element which divides the cavity into a first region for receiving the beverage raw material and into a third region for temporarily storing the incorporated liquid, whereby it is particularly preferably provided that the liquid distribution element comprises a rigid and/or flexible plastics material, the liquid distribution element most particularly preferably having a multiplicity of holes.

According to a preferred embodiment of the present invention it is provided that the identification mark is disposed at least in portions along the circumferential direction of the periphery, the side of the periphery facing away from the lid film being in particular covered by the identification mark substantially completely and uninterrupted in the circumferential direction. Alternatively, the identification mark is provided in regions which are repeated and mutually spaced apart in the circumferential direction. An encircling identification mark advantageously enables the storage of more items of information, while a repeated identification mark enables localized, hence easier, detection.

According to a preferred embodiment of the present invention it is provided that the identification mark is disposed at least in portions along the circumferential direction of the periphery, the side of the periphery facing away from the lid film being in particular covered substantially completely and without interruption in the circumferential direction by the identification mark. Alternatively, the identification mark is provided in regions which are repeated and mutually spaced apart in the circumferential direction. An encircling identification mark advantageously enables more information to be stored, while a repeated identification mark enables localized, hence simpler, detection.

According to a preferred embodiment of the present invention it is provided that the periphery on the radially outer end thereof has a rolled region. In particular in the case of a single serve capsule in which the base element thereof is at least in part made of metal, a rolled periphery of this type is advantageous because this reduces the risk of injury to the user. The single serve capsule is also easier to grip by the user. The rolled periphery particularly preferably extends on both sides of the in particular horizontal plane defined by the periphery.

A further subject matter of the present invention is a method for preparing a beverage by means of a system according to the invention, wherein the identification mark is detected by the detection means before, while and/or after inserting the single serve capsule into the brewing chamber.

The advantages and refinements explained in the context of the method according to the invention also apply in an analogous manner to the other subject matter of the present invention, and vice versa.

According to a preferred embodiment of the present invention it is provided that the identification mark is detected by the detection means before, during or after the movement of the brewing chamber from the open to the closed position. Since the mutual relative position of the single serve capsule and the detection means is defined in particular in the closed position, this position is preferred for detecting the identification mark. In contrast, detection during the movement is advantageous because an incompatible single serve capsule can in this way be ejected before the closed position is reached, and the preparation of the beverage is performed faster as a result of an early transmission of preparation parameters.

According to a preferred embodiment of the present invention it is provided that the detection means for detecting the identification mark is pivoted, preferably along a substantially arcuate distance of a predetermined length. Alternatively or additionally, the detection means and/or the brewing chamber element comprising the detection means are/is rotated about an axis, the axis preferably being identical to the centric central axis of the single serve capsule disposed in the brewing chamber.

Additionally or alternatively, it is provided according to a preferred embodiment of the present invention that the single serve capsule for detecting the detection mark is rotated about a centric central axis of the single serve capsule, preferably in a predetermined angular range of in particular 1° to 360°. The single serve capsule is particularly preferably rotated by at most 180°, at most 90°, at most 45°, or at most 30°.

According to a preferred embodiment of the present invention it is provided that the detection means is provided in such a manner that an identification mark is detected within a detection face, the detection face covering an angular range from 1° to 360°, preferably from 10° to 90°.

As has already been mentioned earlier, this is possible as a result of a corresponding arrangement of the at least one detection means, or of a multiplicity of detection means and/or sensors, and/or as a result of a corresponding beam being formed.

According to a preferred embodiment of the method, in a first step the single serve capsule is introduced into the beverage preparation device, wherein in a second step the identification mark of the single serve capsule is detected by means of the detection means, and wherein in a third step the single serve capsule is transferred into the brewing chamber, and/or the preparation of the beverage is started if the identification mark of the single serve capsule has been detected. In this method, it is advantageously ensured that the single serve capsule is disposed in the closed brewing chamber only if this is a system-related single serve capsule.

Otherwise, the transfer of the brewing chamber to the closed position is prevented, and/or the single serve capsule is not received and drops into a collection container located below the brewing chamber, for example, so as to preclude any damage to the beverage preparation device as a result of a single serve capsule alien to the system being received. Alternatively, it is conceivable that the preparation of the beverage, and in particular the pump for directing the liquid into the single serve capsule, are started only if the presence of a system-related single serve capsule is detected in the second step. This also precludes any potential damage to the beverage preparation device due to the use of a single serve capsule alien to the system.

Yet another subject matter of the present invention is the use of a single serve capsule, the single serve capsule having a base element with an open side and a periphery projecting laterally from the base element on the open side; a lid film which closes, in particular hermetically, the open side being fastened to the periphery; a beverage raw material being disposed in the cavity formed by the lid film and the base element; the single serve capsule on the side of the periphery facing away from the lid film having an identification mark, for preparing a beverage in a beverage preparation device according to the invention, or in a system according to the invention.

The advantages and refinements explained in the context of the use according to the invention also apply in an analogous manner to the other subject matter of the present invention, and vice versa.

Further details, features and advantages of the invention are derived from the drawings, and from the description hereunder of preferred embodiments by means of the drawings. The drawings herein illustrate only exemplary embodiments of the invention which do not limit the substantial concept of the invention.

### BRIEF DESCRIPTION OF THE DRAWINGS

FIG. 1 shows a perspective view of a beverage preparation device according to an exemplary embodiment of the present invention;

FIGS. 2a-d show a single serve capsule according to various exemplary embodiments of the present invention;

FIG. 3 shows a schematic diagram of the detection of an identification mark of a single serve capsule by means of a detection means according to an exemplary embodiment of the present invention;

FIGS. 4a-d show a method for preparing a beverage in a beverage preparation device according to an exemplary embodiment of the present invention; and

FIGS. 5a-b show a method for preparing a beverage in a beverage preparation device according to a further exemplary embodiment of the present invention.

### DETAILED DESCRIPTION

Fundamentally identical elements are provided with the same reference signs in the figures.

Similar elements in different embodiments herein are denoted by dissimilar first digits, for example 101, 201, 301, etc.

Unless points of differentiation are explicitly mentioned, the various embodiments of the figures are substantially identical so that for each figure reference is made in principle to the explanations pertaining to the other figures.

Terms such as length, height and depth, top/bottom, vertical/horizontal are used for improved understanding hereunder. The terms relate in particular to a usual orientation of the elements, such as present when a beverage preparation device 1 is set up on flat surface, for example.

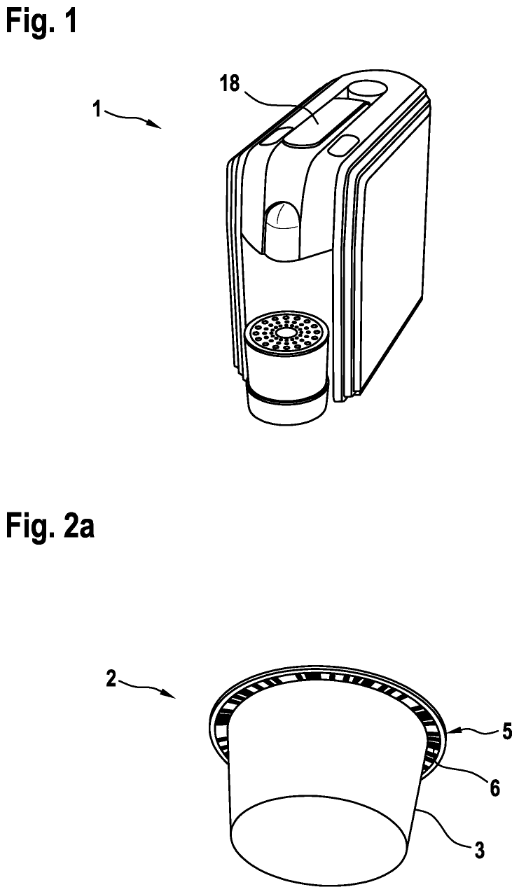

Illustrated in FIG. 1 is a perspective view of a beverage preparation device 1 according to an exemplary embodiment of the present invention. The beverage preparation device 1 illustrated is a single serve capsule machine by way of which a beverage, in particular a hot beverage, can be prepared from beverage raw material contained in single serve capsules 2, for example ground and roasted coffee, instant coffee powder, mild powder and/or tea leaves.

The beverage preparation device 1 herein comprises a housing, a beverage outlet which is provided on the front here and from which the completely prepared beverage flows into a vessel, for example a cup or a beaker, disposed therebelow. The vessel here can be placed at different heights, presently two heights, on a drip grid. A reservoir for receiving liquid dripping through the drip grid is provided below the drip grid. According to the exemplary embodiment illustrated here, an upper reservoir is configured as a removable hollow cylinder with a base.

The drip grid can be easily retrieved and placed above the reservoir lying therebelow. A collection container for receiving used single serve capsules 2 is provided below the beverage outlet here, said collection container being inserted into the housing and able to be retrieved toward the front. This collection container has to be retrieved and emptied after a specific number of beverage servings.

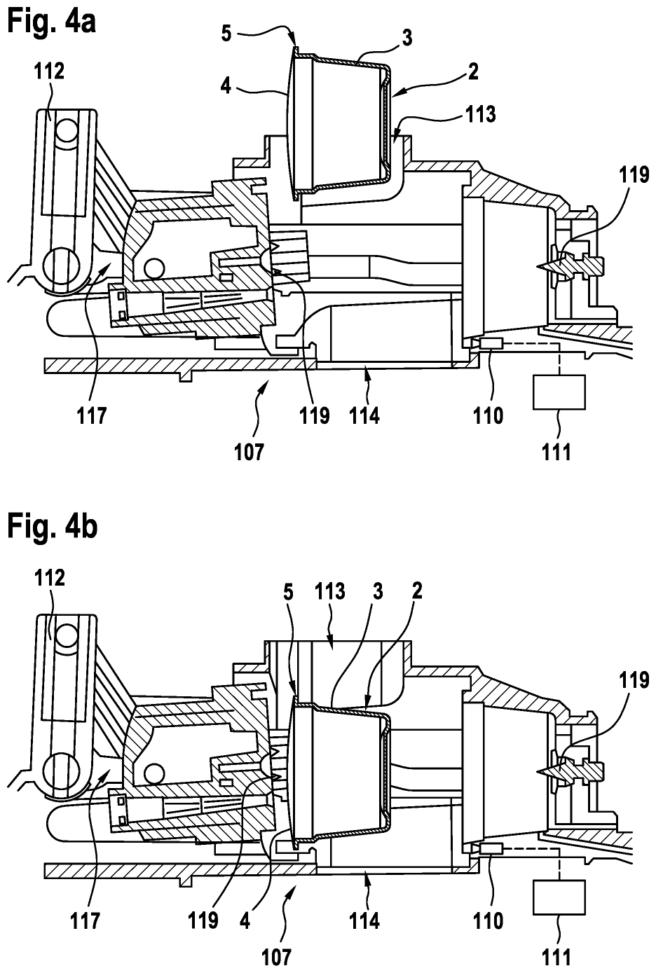

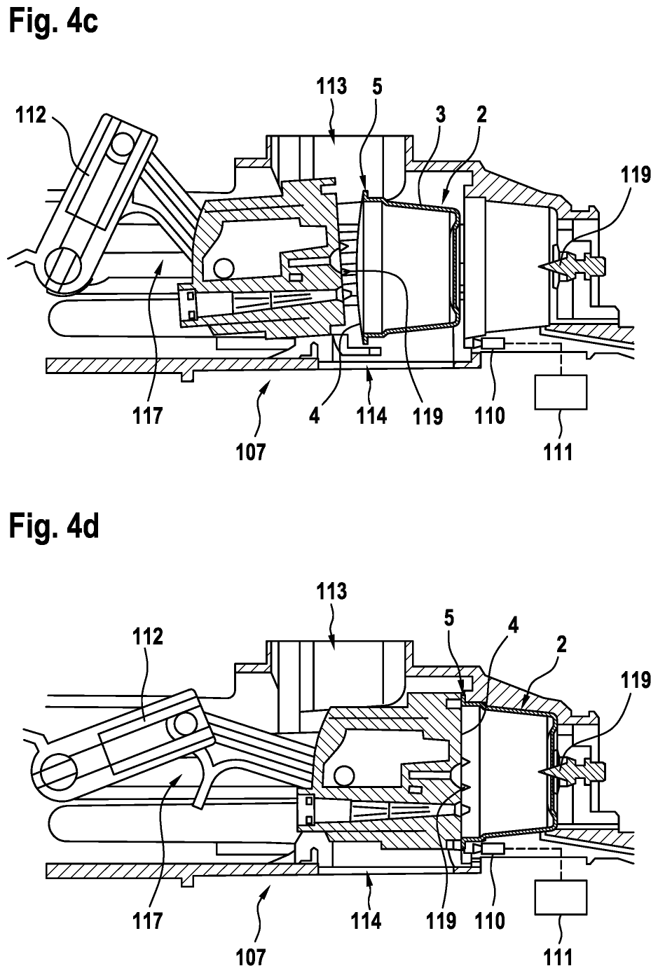

Disposed on the rear side of the beverage preparation device 1 is a retrievable liquid tank, in particular a water tank, which is not illustrated here and provides a liquid to the beverage preparation device 1. The beverage preparation device 1 herein is of a narrow and elongate configuration and has a lever 18 which can be clearly seen on the upper side. Said lever 18 here obscures an introduction opening 13 which is contiguous to an introduction duct by way of which an introduced single serve capsule 2 makes its way by gravity into an open brewing chamber 7. The brewing chamber 7 herein is composed of a first brewing chamber element 8 and of a second brewing chamber element 9 which are movable relative to one another between an open position of the brewing chamber 7 and a closed position. This will be explained in more detail by means of the exemplary embodiment illustrated in FIGS. 4a-d.

Suffice it to say at this stage that, according to the embodiment illustrated in FIG. 1, one brewing chamber element 8, 9 is provided to be immovable, and the other brewing chamber element 9, 8 by means of a corresponding deflection mechanism 112 is displaceable between the open and the closed position by activating the lever 18.

Illustrated here is the closed position in which a preparation of a beverage can take place, for example. In order to prepare a beverage, a user pivots the lever 18 until the latter points approximately vertically upward (it goes without saying that other terminal positions are also possible). In this position, the brewing chamber 7 is in an open position, and the single serve capsule 2 can be placed into the beverage preparation device 1 through the introduction opening 13. Subsequently, the lever 18 is moved back to the horizontal position illustrated here, as a result of which the brewing chamber 7 is transferred to the closed position. In the process, a detection means 10, not illustrated here, before, during or after this movement detects an identification mark 6 attached to the single serve capsule 2. The detection means 10 is particularly preferably functionally connected to a control unit 11 in such a way that the detected identification mark 6 is transmitted to the control unit 11. If no identification mark 6 has been detected, a corresponding item of information is sent to the control unit 11.

Alternatively, the control unit 11 is specified to conclude from the absence of an item of information relating to the identification mark 6 within a predetermined temporal interval that an identification mark 6 is missing or erroneous.

The control unit 11 is preferably specified to compare the detected identification mark 6 with at least one stored identification mark 6, i.e. a reference identification mark, or to compare the item of information received with a reference item of information. If the result of this comparison is negative, i.e. there is no (at least partial) agreement, the control unit 11 is configured in such a manner, for example, that a pump (not illustrated here) conveying the pressurized liquid from the to the brewing chamber 7 is not activated. In this case, the user has to open the brewing chamber 7 by way of the lever 18, and the unused single serve capsule 2 drops into the collection container.

In contrast, if an agreement is detected, the control unit 11 activates the pump and the preparation of the beverage begins, or the control unit 11 releases the pump in such a way that the user can initiate the preparation of the beverage, for example by pushing a button.

Alternatively or additionally, the control unit 11 can also draw conclusions pertaining to at least one preparation parameter from the item of information transmitted, for example the volume of liquid to be supplied, the pressure and/or the temperature at which the liquid is supplied, and/or a pressure and/or temperature profile, i.e. a temporal profile of the pressure, or of the temperature, of the liquid over the duration of the preparation of the beverage.

In addition to the pump, the beverage preparation device 1 typically also comprises further, in particular controllable, components which are likewise not illustrated here for the sake of clarity, such as, for example, a flow meter, a liquid temperature-control device, in particular an instantaneous water heater, a thermoblock and/or a boiler, and/or at least one valve, in particular a solenoid valve.

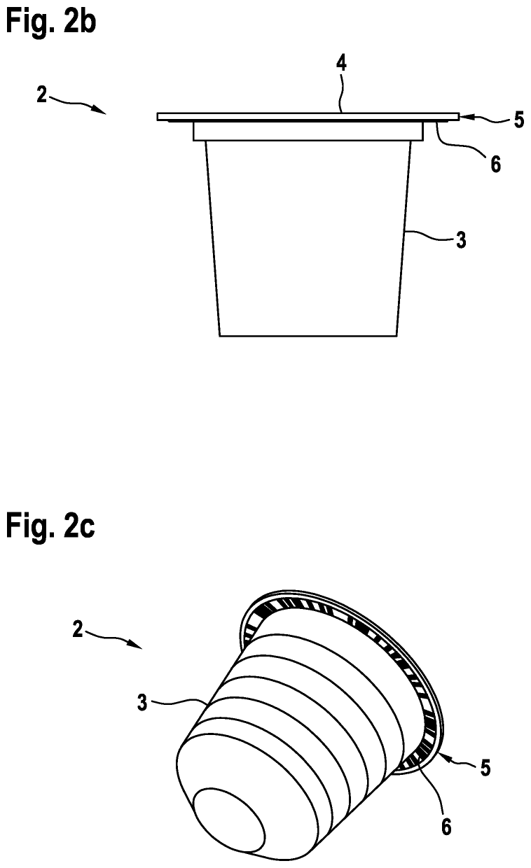

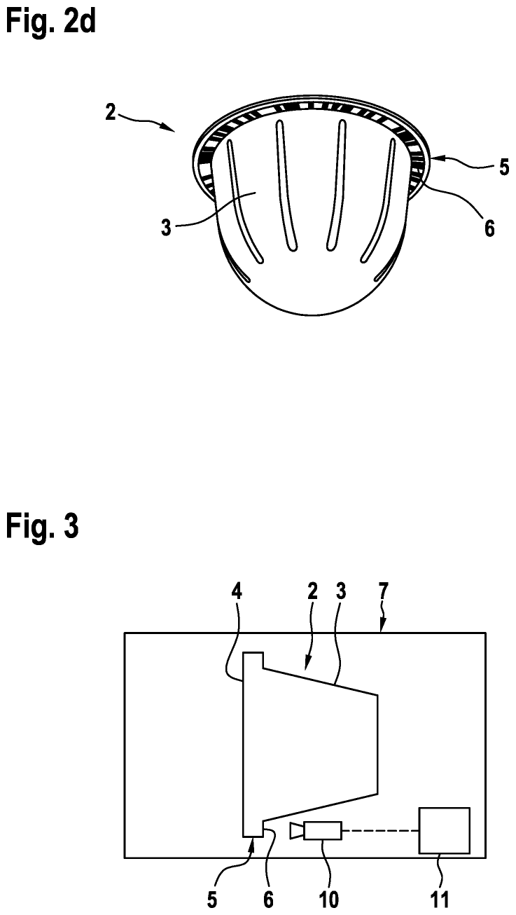

Illustrated in FIGS. 2a-d is a single serve capsule 2 according to various exemplary embodiments of the present invention.

For instance, various forms of capsules are known, all of which are preferably able to be used in the context of the present invention.

It is a common feature of the single serve capsules 2 that they comprise a base element 3 which preferably has an open side that is closed, in particular hermetically, by a lid film 4. For this purpose, the single serve capsules 2 on the open side have an in particular flange-type and/or encircling periphery 5 which projects radially outward from the base element 3 and to which the lid film 4 is fastened. The periphery 5 is particularly preferably aligned so as to be substantially horizontal, i.e. in particular parallel to a plane of the lid film 4. The lid film 4 is most particularly preferably sealed and/or adhesively bonded to this periphery 5.

The base element 3 and the lid film 4 enclose a cavity in which the beverage raw material is disposed.

According to the present invention, the single serve capsules 2 on the side of the periphery 5 facing away from the lid film 4, hereunder also (arbitrarily) referred to as the lower side of the periphery 5, have an identification mark 6 (this not implying a statement pertaining to a preferred orientation of the single serve capsule 2, even in the brewing chamber 7). The identification mark 6 here is preferably machine-readable. This is particularly preferably a bar code (cf. FIG. 2d). Such a bar code is an example of a one-dimensional identification mark and is composed in particular of a sequence of dissimilarly wide dark, in particular black, and bright, in particular white, regions. Such a bar code is readable by a detection means 10, for example in the form of an optical sensor, and can store dissimilar amounts of information, depending on the design embodiment and length. This bar code can be imprinted, be generated by a subtraction of material or be produced using optically identifiable means, for example fluorescent means, present in the periphery 5.

The identification mark 6 is preferably provided across the entire circumference of the periphery 5. Alternatively however, the identification mark 6 is provided only in portions on the periphery 5. In this case, it is preferable for the identification mark 6 to be applied repeatedly at regular spacings on the periphery 5 in such a way that an identification mark 6 is at all times disposed close to the detection means, irrespective of the orientation of the single serve capsule 2, in particular of a rotation about a centric central axis of the single serve capsule 2. It goes without saying that other, in particular machine-readable, identification marks 6 are possible as long as the latter are provided on the side of the periphery 5 facing away from the lid film 4 and are able to be detected by a suitably positioned detection means 10.

The single serve capsule 2 illustrated in FIG. 2a is a single serve capsule 2 with a substantially frustoconical base element 3. The base element 3 thus has a lateral wall which, proceeding from the periphery 5 or the lid film 4, tapers in the direction of a base region. The base region here is of a substantially flat configuration, but may in principle be of any arbitrary shape. A single serve capsule shape of this type is present in the K-fee single serve capsules of the applicant, for example.

The base element 3 is presently made preferably of a plastics material, in particular injection-molded or deep-drawn. The lid film 4 is preferably likewise made at least in part of a plastic film. The lid film 4 is particularly preferably configured in multiple layers and has in particular at least one at least partially metallic layer, for example an aluminum foil.

The position of the identification mark 6 is schematically illustrated in more detail, on the one hand, in the lateral view shown FIG. 2b which is associated with the single serve capsule 2 shown in FIG. 2a, for example, and it can be seen on the other hand that the single serve capsule 2 according to the embodiment illustrated here, at a predetermined spacing below the periphery 5, in the lateral wall has a shoulder which can serve as a stacking shoulder, for example. However, this shoulder is in particular of no further relevance in the context of the present concept of the invention, and is therefore not discussed in more detail.

Illustrated in FIG. 2c is a single serve capsule 2 according to a further potential embodiment. This here is a single serve capsule 2, the shape of the latter corresponding to a Nespresso capsule of the company Nestle. The base element 3 shown here is similar to the base element 3 shown in FIG. 2a, but does not have a flat base region, but a cupola-shaped tapered base region. The single serve capsule 2 here comprises encircling grooves on the lateral wall, but these are purely optional. A base element 3 of this type is preferably made of a metal material, for example of an aluminum foil or an aluminum alloy, in particular deep-drawn. Additionally, the base element 3 can be provided with a coating on one side or both sides, for example a barrier layer which is at least in part composed of PP.

Finally illustrated in FIG. 2d is a further potential embodiment of the single serve capsule 2. This embodiment comprises a base element 3 which is dome-shaped, or at least in regions configured to be substantially hemispherical. A base element 3 of such a configuration is to be found, for example, in single serve capsules of the Vertuo system by Nestle. These single serve capsules 2 are of a rotationally symmetrical configuration and are set in rotation in the brewing chamber. Water is injected centrally, penetrating the beverage raw material disposed in the base element 3 while forming the beverage, the latter then being ejected through the lid film 4 at the periphery 5 as a result of centrifugal forces. The base element 3 here additionally has elongate grooves for reinforcing the base element 3, but these are purely optional.

Clearly to be seen in FIG. 2d is the identification mark 6 which in the form of an encircling bar code is disposed on the lower side of the periphery 5. In single serve capsule machines of the Vertuo system, the single serve capsules are rotated for the preparation of the beverage, as has already been discussed above. In the process, the bar code moves past a stationary sensor which can thus completely read the bar code within one 360° rotation.

However, a rotation of this type of the capsule at the rotating speeds required for generating an espresso-type beverage, for example, is complex. Moreover, a beverage generated by centrifugation, in terms of the organoleptic qualities, cannot be compared with a beverage generated by classic extraction at a liquid pressure of 5 to 15 bar, in particular approximately 9 bar for espresso. Centrifugation is also detrimental in terms of crema, which tends to be used as a quality feature for espresso and is a foam layer on the beverage generated by the pressurized extraction.

In contrast, the identification mark 6 on the side of the periphery 5 facing away from the lid film 4 is advantageous. The identification mark 6 there is protected against damage, and a sufficiently large quantity of information can be stored by said identification mark 6. Moreover, an associated detection means 10 can be protected from the pressurized liquid or beverage, if correspondingly positioned.

It is, therefore, desirable that a single serve capsule 2 with an identification mark 6 on the lower side, i.e. on the side of the periphery 5 facing away from the lid film 4, should also be able to be used together with conventional beverage preparation devices 1 which do not provide centrifugation of the single serve capsule 2.

It is a common feature of all previously described embodiments of the single serve capsule 2 that said embodiments can optionally contain even further components such as, for example, at least one filter element and/or at least one liquid distribution element. These components here are selectively placed loosely into the base element, jammed into the latter, and/or at least in portions fastened to the base element, for example adhesively bonded or sealed to the latter.

Illustrated in FIG. 3 is a schematic diagram of the detection of an identification mark 6 of a single serve capsule 2 by means of a detection means 10 according to an exemplary embodiment of the present invention. The outer border, only schematically illustrated, symbolically represents a detection environment. This can be, for example, a brewing chamber 7 of the beverage preparation device 1, preferably in the closed position, or an introduction duct of the beverage preparation device 1. The detection means 10 is preferably connected to a control unit 11 of the beverage preparation device 1.

According to a particularly preferred embodiment, the detection means 10 is disposed on an external side of the beverage preparation device 1 in such a way that a user can verify the identification mark 6 prior to insertion into the beverage preparation device 1. For example, the housing of the beverage preparation device 1 comprises a depression which receives the base element 3. When the single serve capsule 2, or the base element 3, is inserted into this depression, or held in the latter, at least one detection means 10, in particular an optical sensor, is disposed in such a manner that the latter can detect at least a portion of the identification mark 6, but preferably the entire identification mark 6. For example, the at least one detection means 10 is provided so as to be at least partially annular. The beverage preparation device 1 particularly preferably provides the user with optical and/or acoustic feedback pertaining to whether the identification mark 6 has been detected and/or not detected, or whether the single serve capsule 2 is compatible and/or incompatible with the beverage preparation device 1.

Illustrated in FIGS. 4a-d is a method for preparing a beverage in a beverage preparation device 1 according to an exemplary embodiment of the present invention. The functional mode and the mechanism of the brewing chamber 107 illustrated is already well known, so that the aspects relevant to the present invention are above all discussed here. In terms of the design embodiment of the construction and the functional mode of the brewing chamber 107 illustrated, reference is made in particular to publication WO 2014/001516 A2, the disclosed content of the latter in this respect being herewith incorporated in the present disclosure.

The embodiment of the beverage preparation device 1 illustrated in FIGS. 4a-d preferably corresponds substantially to the embodiment explained in the context of FIG. 1.

In FIG. 4a, the brewing chamber 107, composed of a first brewing chamber element 108 and of a second brewing chamber element 109, is illustrated in an opened position. The second brewing chamber element 109 here is disposed so as to be immovable, i.e. stationary, relative to the housing of the beverage preparation device 1, and is configured in such a manner that said second brewing chamber element 109 can receive the base element 3 of the single serve capsule 2 in a substantially form-fitting manner. The second brewing chamber element 109 in the base has a piercing means 119, for example a piercing spike, which is provided to pierce through the base region of the base element 3 in order to enable the beverage to flow out.

The first brewing chamber element 108 is provided to be movable relative to the second brewing chamber element 109, and can be moved along a guide gate 117, between the open or opened position of the brewing chamber 107 and the closed position, by way of a correspondingly suitable deflection mechanism 112, which is coupled to a lever 118 as illustrated in FIG. 1, for example.

In the opened position shown here, the introduction opening 113 has been exposed by the lever 118, and a user has introduced a single serve capsule 2, for example according to the embodiment explained in the context of FIGS. 2a and 2b, into the introduction duct. The introduction duct preferably guides the single serve capsule 2 by gravity in a form-fitting manner, and thus in a correct position and orientation, between the two brewing chamber elements 108, 109. The first brewing chamber element 108 has holding means which are not visible here and hold the single serve capsule 2 counter to gravity. This position is shown in FIG. 4b.

When the user now pivots the lever 118 to the closed position again, in particular thus the horizontal position, the single serve capsule 2 is moved by the first brewing chamber element 108 from the left to the right in the drawing, i.e. in the direction of the second brewing chamber element 109, as is shown in FIG. 4c.

The second brewing chamber element 109 has a detection means 110, for example a camera, which is disposed on at least one location which in the closed position of the brewing chamber 107 lies directly opposite the identification mark 6. According to the embodiment illustrated here, the detection means 110 is only schematically indicated and byway of example disposed in the lower region of the second brewing chamber element 109. However, the person skilled in the art understands that the detection means 110 can in principle also be provided at any other position along the circumference of the periphery 5 in the closed position. Furthermore, a plurality of detection means 110 which are disposed along the circumference can also be provided. It is in particular also conceivable that a multiplicity of detection means 110 are provided, the sum of the detection faces of the latter detecting the entire periphery 5 of the single serve capsule 2.

If only one or a few detection means 110 is/are provided, it can be necessary for the detection means 110 to be pivoted in the circumferential direction and/or moved along the circumference, thus rotated about an axis running centrally through the brewing chamber 107, or the single serve capsule 2, respectively, in order to detect a sufficient region of the periphery 5, or of the identification mark 6, respectively. Alternatively or additionally, the single serve capsule 2 is rotatable about its centric central axis at least in a predetermined angular range in order to detect the identification mark 6. However, it is decisive that the single serve capsule 2 as well as the brewing chamber, in particular the first brewing chamber element 108 and the second brewing chamber element 109, are immovable, i.e. are in particular not rotated, during the preparation of the beverage, i.e. while the liquid is being directed through the single serve capsule 2.

In the closed position of the brewing chamber 107 which is illustrated in FIG. 4d, piercing means 119, which according to the embodiment illustrated here are disposed on a face of the first brewing chamber element 108 contacting the lid film 4, pierce the lid film 4. The first brewing chamber element 108 and the second brewing chamber element 109 tightly enclose the single serve capsule 2 in the closed position, optionally using at least one sealing means (for example an annular seal which contacts the periphery 5 by pressing on the latter). Liquid, which is preferably pressurized and/or hot, is now directed through the holes made in the lid film 4 into the single serve capsule 2 and, conjointly with the beverage raw material disposed therein, forms the beverage which exits the single serve capsule 2 through the base region and is discharged into the vessel.

The detection means 110 is connected to a control unit 111 of the beverage preparation device 1, and upon detection of the identification mark 6 transmits an item of information related to said detection to the control unit 111. The control unit 111 preferably compares the identification mark 6 with a stored identification mark, for example a reference identification mark. The person skilled in the art understands that this applies in an analogous manner also to an item of information which is not necessarily identical to the identification mark 6 but is unequivocally correlated with the latter.

If the control unit 111 establishes an agreement between the identification mark 6 and the reference identification mark, or the item of information and the reference item of information, respectively, a preparation of a beverage is preferably released. For example, the control unit 111 activates the pump, or enables the user to activate the pump by activating a corresponding activation means such as a button or a command button. Conversely, should an unsuitable single serve capsule 2 be inserted, this means that preferably the control unit 111 prevents the activation of the pump, thus preventing damage to the beverage preparation device 1 or even injury to the user as a result of a leak and/or a bursting single serve capsule 2, and any associated uncontrolled discharge of pressurized hot liquid.

Alternatively or additionally, the control unit 111 can also draw conclusions pertaining to at least one preparation parameter from the item of information transmitted by the detection means 110, for example the volume of liquid to be supplied, the pressure and/or the temperature at which the liquid is supplied, and/or a pressure and/or temperature profile, i.e. a temporal profile of the pressure or temperature of the liquid over the duration of the preparation of the beverage. The control unit 111 can directly control the preparation of a beverage in this way.

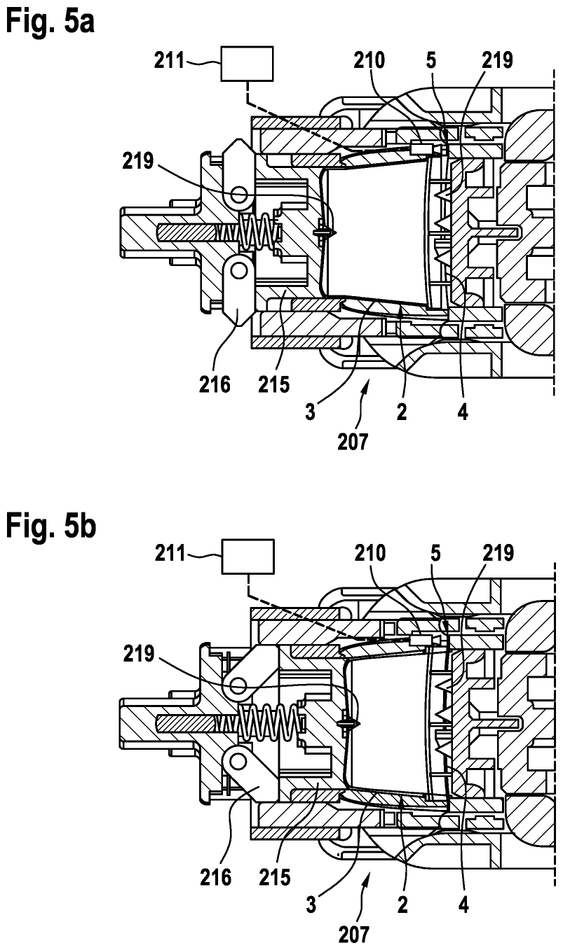

Shown in FIGS. 5a and 5b is a method for preparing a beverage in a beverage preparation device 1 according to a further exemplary embodiment of the present invention. The functional mode and the mechanism of the brewing chamber 207 illustrated here is already well known, so that the aspects relevant to the present invention are above all discussed here. In terms of the design embodiment of the construction and the functional mode of the brewing chamber 207 illustrated, and most particularly the volumetric adaptation of the brewing chamber 207, reference is made in particular to publication WO 2021/028472 A1, the disclosed content of the latter in this respect being herewith incorporated in the present disclosure.

The brewing chamber 207 shown here is provided to be of a variable volume, i.e. said brewing chamber 207 can receive two single serve capsules 2 of similar configuration with dissimilar axial lengths and thus dissimilar volumes. In particular, the diameter of the single serve capsules 2, or the diameter of the periphery 5, respectively, is invariable here. For this purpose, the second brewing chamber element 209 has at least one volumetric adaptation element 215.

According to the embodiment illustrated, the base of the second brewing chamber element 209 is provided to be displaceable between at least two positions along the centric central axis. Illustrated in FIG. 5a is a position in which a single serve capsule 2 with a larger volume is inserted, and the volumetric adaptation element 215, as a result of contact with the base region of the single serve capsule 2, has consequently moved to the left in order to receive the larger volume of the single serve capsule 2.

In contrast, illustrated in FIG. 5b is the position in which the volumetric adaptation element 2105 provides a smaller volume of the brewing chamber 207 in order to receive a single serve capsule 2 with a smaller volume. Blocking means 216 which due to a form-fit prevent an adjustment are provided to lock the volumetric adaptation means 215 in this position, thus preventing any inadvertent adjustment.

The brewing chamber 207 illustrated provides a purely mechanical concept of volumetric adaptation of the brewing chamber 207. In terms of further details, reference is made to the publication mentioned above.

The introduction and ejection of the single serve capsule 2 into the brewing chamber 207, or from the brewing chamber 207, respectively, herein takes place in a manner analogous to the embodiment explained in the context of FIGS. 4a-d, i.e. by way of an introduction opening 213 not illustrated here and an ejection opening 214. As in the embodiment illustrated in FIGS. 4a-d, the first brewing chamber element 208 here is also provided to be movable by means of a suitable mechanism 212.

The second brewing chamber element 209 here is now partially movable because the base of the second brewing chamber element 209, i.e. the volumetric adaptation element 215, is movable while the wall of the second brewing chamber 209 is not movable. The second brewing chamber element 209 in the region opposite the identification mark 6 has at least one detection means 210. The latter here, by way of example, is provided in the upper region; but as in the embodiment of FIGS. 4a-d a different position and/or an additional number of detection means 210 is also conceivable.

Here too, the detection means 210 is preferably functionally connected to a control unit 211 in such a way that, by identifying the identification mark 6 by the detection means 210, the beverage preparation device 1 is at least partially controllable by the control unit 211.

Depending on the design embodiment of the identification mark 6, it may also be necessary here that the detection means 210 and/or the single serve capsule 2 are moved, in particular rotated at least in portions about the centric central axis of the single serve capsule 2, or of the brewing chamber 207, in order for the identification mark 6 to be detected.

It goes without saying that this embodiment, in which the detection means 210 is disposed in the second brewing chamber element 209, is also able to be combined with the embodiment discussed in the context of FIG. 3, in which an additional detection means is provided on an external side of the beverage preparation device 1. It is ensured in this way that the compatible single serve capsule 2 selected by the user has actually been inserted into the beverage preparation device 1.

### LIST OF REFERENCE SIGNS

1 Beverage preparation device
2 Single serve capsule
3 Base element
4 Lid film
Periphery
6 Identification mark
7, 107, 207 Brewing chamber
8, 108, 208 First brewing chamber element
9, 109, 209 Second brewing chamber element
10, 110, 210 Detection means
11, 111, 211 Control unit
112, 212 Mechanism
13, 113, 213 Introduction opening
114, 214 Ejection opening
215 Volumetric adaptation element
216 Blocking means
117 Guide gate
18, 118 Lever
119, 219 Piercing means

1)-20) (canceled)

21) A beverage preparation device for preparing a beverage with a single serve capsule, the single serve capsule including: a base element with an open side and a periphery projecting laterally from the base element at the open side, a lid film fastened to the periphery to the open side, a beverage raw material disposed in the cavity formed by the lid film and the base element, and an identification mark on a side of the periphery that faces away from the lid film; the beverage preparation device including a brewing chamber configured to receive the single serve capsule; the brewing chamber comprising: a first brewing chamber element and a second brewing chamber element which are movable relative to one another between an open position, in which the single serve capsule is insertable into the brewing chamber and/or removable from the brewing chamber and a closed position, in which a liquid is configured to be directed into the single serve capsule for preparing the beverage; the beverage preparation device including at least one detection means that is configured to detect the identification mark; the brewing chamber and the single serve capsule are configured to be non-rotating during preparation of the beverage, wherein the beverage preparation device, in the open position and/or the closed position, is configured so that the single serve capsule is pivotable and/or rotatable.

22. The beverage preparation device as claimed in claim 21, wherein the beverage preparation device includes an introduction opening for introducing the single serve capsule; the detection means being disposed along a path between the introduction opening and the brewing chamber in an introduction duct which directs, in a form-fitting manner, the single serve capsule from the introduction opening to the brewing chamber.

23. The beverage preparation device as claimed in claim 21, wherein the first brewing chamber element and/or the second brewing chamber element comprise the detection means, the detection means is configured to detect the identification in the closed position of the beverage preparation device.

24. The beverage preparation device as claimed in claim 21, wherein the detection means is provided on an external side of the beverage preparation device in a depression that is configured to at least partially receive the single serve capsule.

25. The beverage preparation device as claimed in claim 21, wherein the beverage preparation device comprises a control unit that is connected to the detection means, the detection means is configured to send information to the control unit after the identification mark is detected; the control unit is configured to control the beverage preparation device at least in part as a function of the information received from the detection means.

26. The beverage preparation device as claimed in claim 21, wherein the detection means comprises an optical sensor and/or a CCD sensor and/or a camera, the optical sensor is configured to operate in a wavelength range of 100 to 400 nm, 400 to 600 nm, or 800 nm to 1 mm.

27. The beverage preparation device as claimed in claim 21, wherein the detection means includes an optical transmitter for emitting electromagnetic radiation in a wavelength range of 100 to 400 nm, 400 to 600 nm, or 800 nm to 1 mm, the optical transmitter being or including an LED and/or a laser diode.

28. The beverage preparation device as claimed in claim 21, wherein the detection means includes a detection face in which the identification mark is detectable, the detection face comprising an angular range from 10 to 360°; 1° to 180°; 1° to 90°; 1° to 45°; or 1° to 30°

29. The beverage preparation device as claimed in claim 21, wherein the beverage preparation device in the open and/or the closed position is provided in such a manner that the single serve capsule for detecting the identification mark by the detection means is provided to be pivotable and/or rotatable, in an angular range from 10 to 360°, 1° to 180°, 1° to 90°, 1° to 45°, or 1° to 30°.

30. A system comprising the beverage preparation device as claimed in claim 21.

31. The system as claimed in claim 30, wherein the identification mark comprises a one-dimensional identification mark and/or a bar code.

32. The system as claimed in claim 30, wherein the identification mark is disposed at least in portions along a circumferential direction of the periphery, and the side of the periphery facing away from the lid film is covered completely and without interruption in the circumferential direction by the identification mark.

33. The system as claimed in claim 30, wherein the periphery has a rolled region on a radially outer end of the periphery.

34. A method for preparing the beverage with the system as claimed in claim 30, wherein the method comprises detecting the identification mark with the detection means before, while, and/or after a step of inserting the single serve capsule into the brewing chamber.

35. The method as claimed in claim 34, wherein the method comprises detecting the identification mark by the detection means before, during, or after movement of the brewing chamber from the open position to the closed position.

36. The method as claimed in claim 34, wherein the method comprises rotating the single serve about a central axis of the single serve capsule in a predetermined angular range of 1° to 360°.

37. Use of the single serve capsule for preparing the beverage in the system of claim 30.
